(19) United States
(12) Patent Application Publication
(10) Pub. No.: US 2005/0259199 A1
(43) Pub. Date: Nov. 24, 2005

(54) Liquid crystal display device and electronic apparatus

(75) Inventor: Tsuyoshi Maeda, Kai (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/093,226

(22) Filed: Mar. 30, 2005

(30) Foreign Application Priority Data
May 20, 2004 (JP) 2004-150463

(51) Int. Cl. G02F 1/1335

(52) U.S. Cl. 349/117

(57) ABSTRACT

To ensure an aperture ratio and enhance display characteristic as viewed from a wide angle side. There is provided a liquid crystal display device having a liquid crystal interposed between a pair of substrates, in which an electric field parallel to a surface of each of the substrates is applied to the liquid crystal, thereby changing a display state. The liquid crystal display device comprises a retardation film arranged at a side opposite to the liquid crystal of one substrate of the substrates, a first polarizing plate which is arranged at a side opposite to the substrate of the retardation film and which has a transmission axis parallel to an alignment direction of the liquid crystal, and a second polarizing plate which is arranged at a side opposite to the liquid crystal of the other substrate and which has a transmission axis orthogonal to the alignment direction of the liquid crystal.

### BACKGROUND

The present invention relates to a liquid crystal display device.

In a liquid crystal display device using a TN (Twisted Nematic) liquid crystal, conventionally, there is a problem in that a viewing angle is narrow. In order to solve the problem, it has been proposed an in-plane switching (IPS) mode liquid crystal display device in which an electric field parallel to a surface of a substrate (hereinafter, referred to as a lateral electric field) is applied to the liquid crystal, thereby changing a display state (see Patent Document 1). However, even in the IPS mode liquid crystal display device, as viewed from a wide angle side, light leakage occurs in a case of a black display. Further, in a case of a white display, deterioration in display characteristic such as coloring problems of blue or yellow occurs.

In order to solve the problems of the IPS mode liquid crystal display device, it has been proposed a technology in which an electrode for applying the lateral electric field to the liquid crystal is formed in a V shape such that the coloring problem at the time of the white display is prevented (see Patent Document 2). Specifically, the electrode is formed in the V shape, and thus two liquid crystal operation regions are formed in one pixel. Further, in one liquid crystal operation region, the white display is colored blue and, in the other liquid crystal operation region, the white display is colored yellow. Blue and yellow are in a complementary color relationship, and thus the coloring problem of the white display in one pixel is prevented.
[Patent Document 1] Japanese Unexamined Patent Application Publication No. 6-160878
[Patent Document 2] Japanese Unexamined Patent Application Publication No. 10-148826
[Patent Document 3] Japanese Unexamined Patent Application Publication No. 9-80424
[Patent Document 4] Japanese Unexamined Patent Application Publication No. 11-133408
[Patent Document 5] Japanese Unexamined Patent Application Publication No. 2001-242462
[Patent Document 6] Japanese Unexamined Patent Application Publication No. 2002-55341
[Patent Document 7] Japanese Unexamined Patent Application Publication No. 2003-195310

### SUMMARY

However, when the electrode is formed in the V shape, the shape of the electrode is complex as compared to a conventional IPS mode liquid crystal display device having a rectangular electrode, and it is difficult to ensure the aperture ratio in one pixel. For this reason, the V-shaped electrode is difficult to be adopted for a liquid crystal display device which realizes high definition image quality.

The present invention has been made in consideration of the above-described problems, and it is an object of the present invention to provide a liquid crystal display device and an electronic apparatus which can ensure an aperture ratio and can enhance display characteristic as viewed from a wide angle side.

In order to achieve the above-described objects, there is provided a liquid crystal display device according to the present invention having a liquid crystal interposed between a pair of substrates, in which an electric field parallel to a surface of each of the substrates is applied to the liquid crystal, thereby changing a display state. The liquid crystal display device comprises a retardation film arranged at a side opposite to the liquid crystal of one of the substrates, a first polarizing plate which is arranged at a side opposite to the substrate of the retardation film and which has a transmission axis parallel to an alignment direction of the liquid crystal, and a second polarizing plate which is arranged at a side opposite to the liquid crystal of the other substrate and which has a transmission axis orthogonal to the alignment direction of the liquid crystal.

According to such a liquid crystal display device of the present invention, on the retardation film arranged at the side opposite to the liquid crystal of the one substrate, the first polarizing plate which is arranged at the side opposite to the substrate of the retardation film and which has the transmission axis parallel to the alignment direction of the liquid crystal is arranged. That is, in the liquid crystal display device of the present invention, the transmission axis direction of the first polarizing plate which is arranged at the side opposite to the liquid crystal of the one substrate is in a state parallel to the alignment direction of the liquid crystal with the retardation film interposed therebetween.

According to the liquid crystal display device of the present invention having such a configuration, when a black display is viewed from a wide angle side, light leakage can be suppressed, and thus the display characteristic as viewed from the wide angle side can be enhanced.

Further, in the liquid crystal display device of the present invention, the transmission axis direction of the first polarizing plate which is arranged at the side opposite to the liquid crystal of the one substrate is parallel to the alignment direction of the liquid crystal with the retardation film interposed therebetween. Thus, display characteristic as viewed from the wide angle side can be enhanced, and it is not necessary to form the V-shaped electrode. For this reason, according to the liquid crystal display device of the present invention, an aperture ratio in one pixel can be ensured.

Further, in the liquid crystal display device of the present invention, a slow axis of the retardation film and the alignment direction of the liquid crystal are preferably parallel to each other.

By adopting such a configuration, when the black display is viewed from the wide angle side, light leakage can be further suppressed, and thus display characteristic as viewed from the wide angle side can be enhanced.

Further, the liquid crystal display device of the present invention may have a configuration that a plurality of retardation films are provided.

Even when such a configuration is adopted, as described above, in the liquid crystal display device of the present invention, the retardation film is arranged at the side opposite to the liquid crystal of the one substrate. Then, even if the plurality of retardation films are arranged at the side opposite to the liquid crystal of the one substrate, when the black display is viewed from the wide angle side, light leakage can be suppressed, and thus the display characteristic as viewed from the wide angle side can be enhanced.

To the contrary, in the liquid crystal display device of the present invention, when the plurality of retardation films are provided, some of the retardation films may be arranged at the side opposite to the one substrate and others may be arranged at the side of the other substrate. When the black display is viewed from the wide angle side, however, light leakage cannot be efficiently suppressed. For this reason, in the liquid crystal display device of the present invention, when the plurality of retardation films are provided, all the retardation films are preferably arranged at the side opposite to the liquid crystal of the one substrate.

Further, in the liquid crystal display device of the present invention, preferably, the value of Nz of the retardation film is in a range of from 0.3 to 0.6 and an in-plane phase difference of the retardation film is in a range of from 100 to 250 nm. Moreover, the value of Nz is defined by the following equation (1), and the in-plane phase difference (R) is defined by the following equation (2). Further, in the following equations (1) and (2), nx is a refractive index of the retardation film in an X direction parallel to a surface of the retardation film, ny is a refractive index in a Y direction parallel to the surface of the retardation film and orthogonal to the X direction, nz is a refractive index of the retardation film in a thicknesswise direction (a Z direction) of the retardation film, and d is the thickness of the retardation film.
Nz=(nx−nz)/(nx−ny) (1)
R=(nx−ny)×d (2)

By using such a retardation film, as viewed from the wide angle side, light leakage of the black display and the coloring problem of the white display can be suppressed, and thus the display characteristic as viewed from the wide angle side can be further enhanced.

Next, there is provided an electronic apparatus comprising a liquid crystal display device of the present invention.

According to the liquid crystal display device of the present invention, the aperture ratio in one pixel is ensured and the display characteristic as viewed from the wide angle side is enhanced. For this reason, according to the electronic apparatus of the present invention, the display characteristic of the electronic apparatus can be enhanced.

### BRIEF DESCRIPTION OF THE DRAWINGS

FIG. 1 is a cross-sectional view showing a schematic configuration of a liquid crystal display device according to an embodiment of the present invention;

FIGS. 2A and 2B are plan views schematically showing pixel electrodes, common electrodes, and liquid crystal molecules;

FIG. 3 is a diagram for explaining an operation of the liquid crystal display device according to the embodiment of the present invention;

FIG. 4 is a diagram for explaining an examination result of the present invention;

FIG. 5 is a diagram for explaining an examination result of the present invention;

FIGS. 6A to 6D are diagrams for explaining an examination result of the present invention;

FIGS. 7A to 7D are diagrams for explaining an examination result of the present invention;

FIGS. 8A to 8D are diagrams for explaining an examination result of the present invention;

FIGS. 9A to 9D are diagrams for explaining an examination result of the present invention;

FIG. 10 is a cross-sectional view showing the best configuration of the liquid crystal display device according to the embodiment of the present invention; and

FIG. 11 is a perspective view showing an example of an electronic apparatus according to the present invention.

### DETAILED DESCRIPTION OF EMBODIMENTS

Hereinafter, a liquid crystal display device and an electronic apparatus according to an embodiment of the present invention will be described with reference to the drawings. Moreover, in the drawings, a reduced scale of each member or each layer is suitably changed so that each member or each layer can be fully recognized.

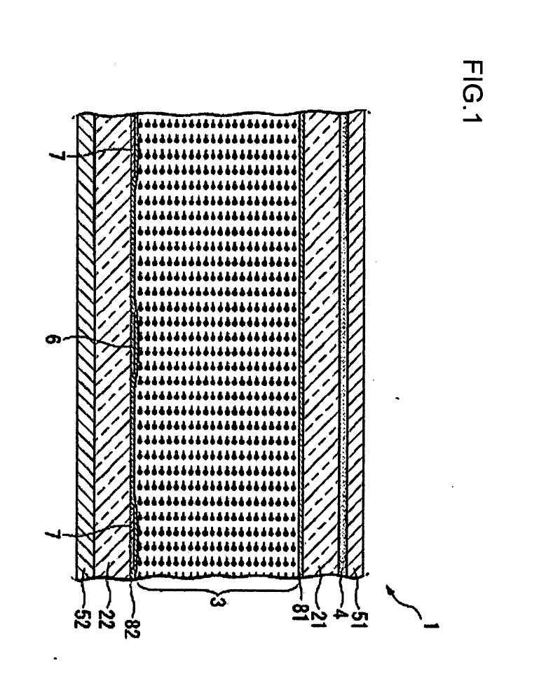

FIG. 1 is a cross-sectional view showing a schematic configuration of a liquid crystal display device 1 of the present embodiment.

As shown in FIG. 1, the liquid crystal display device 1 of the present embodiment has a pair of substrates 21 and 22, a liquid crystal layer 3 (liquid crystal) interposed between the pair of substrates 21 and 22, a retardation film 4 arranged at a side opposite to the liquid crystal layer of the substrate 21, a first polarizing plate 51 arranged at a side opposite to the substrate of the retardation film 4, a second polarizing plate 52 arranged at a side opposite to the liquid crystal layer of the substrate 22, pixel electrodes 6, and common electrodes 7.

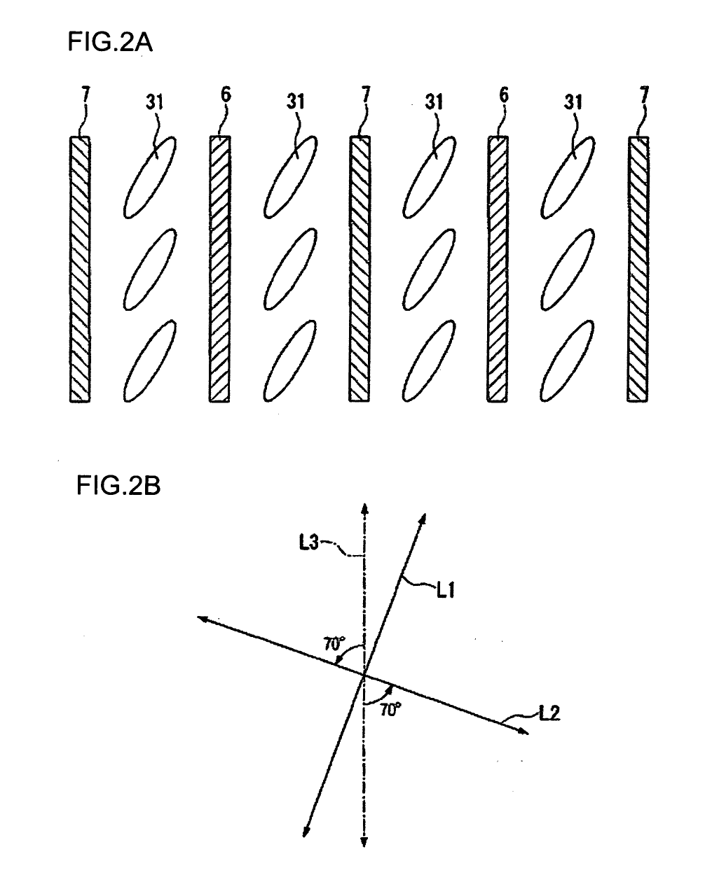

Moreover, FIGS. 2A and 2B are plan views schematically showing the pixel electrodes 6, the common electrodes 7, and the liquid crystal molecules 31. FIGS. 2A and 2B shows the liquid crystal display device 1 shown in FIG. 1 as viewed from top.

In the liquid crystal display device 1 of the present embodiment, the substrates 21 and 22 are made of a light-transmissive material such as glass or plastic.

On the substrate 22 (the other substrate), the pixel electrodes 6 and the common electrodes 7 which extend in a vertical direction of the paper are formed. The pixel electrodes 6 and the common electrodes 7 are made of a light-transmissive conductive material (for example, ITO) and are alternately arranged, as shown in FIG. 2A. Moreover, in FIG. 2A, two pixel electrodes 6 and three common electrodes 7 are shown, but, on the substrate 21, a plurality of pixel electrodes 6 are arranged to correspond to pixels respectively and a plurality of common electrodes 7 are formed with the pixel electrode 6 therebetween. Further, in the present embodiment, one pixel electrode is arranged for each pixel, but the present invention is not limited to this configuration. For example, a plurality of pixel electrodes may be arranged for each pixel.

Below the substrate 22, the second polarizing plate 52 is arranged. As shown in FIG. 2B, the second polarizing plate 52 has a transmission axis L2 inclined by 70° in a counterclockwise direction with respect to a direction L3 that the pixel electrode 6 and the common electrode 7 extend. The second polarizing plate 52 transmits only light components parallel to the transmission axis L2 among light components which are incident from the bottom of the liquid crystal display device 1.

Further, on the substrate 22, an alignment film 82 is arranged to cover the pixel electrodes 6 and the common electrodes 7. The alignment film 82 is made of an organic thin film such as polyimide or the like and is subject to rubbing treatment in a direction orthogonal to the transmission axis L2 shown in FIG. 2B.

Below the substrate 21 (one substrate), an alignment film 81 which is subject to rubbing treatment in the same direction as that of the alignment film 82 arranged on the substrate 22 is arranged. Then, the liquid crystal layer 3 is interposed between the substrate 21 and the substrate 22. Specifically, the liquid crystal layer 3 is interposed between the substrate 21 and the substrate 22 and comes in contact with the alignment films 81 and 82.

Further, on the substrate 21, the first polarizing plate 51 is arranged. As shown in FIG. 2B, the first polarizing plate 51 has a transmission axis L1 orthogonal to the transmission axis L2 of the second polarizing plate 52. The first polarizing plate 51 transmits only light components parallel to the transmission axis L1 among the light components transmitted through the liquid crystal layer 3. Moreover, the substrate 21 and the substrate 22 are bonded to each other by means of a sealing member (not shown).

Here, as described above, the alignment film 81 and the alignment film 82 are subject to rubbing treatment in the direction orthogonal to the transmission axis L2, that is, the direction parallel to the transmission axis L1, and thus the liquid crystal molecules 31 of the liquid crystal layer 3 are aligned in a direction parallel to the transmission axis L1 of the first polarizing plate 51, as shown in FIG. 2A.

That is, in the liquid crystal display device 1 of the present embodiment, the transmission axis L1 of the first polarizing plate 51 arranged on the substrate 21 with the retardation film 4 interposed therebetween is in the direction parallel to the alignment direction of the liquid crystal molecules 31.

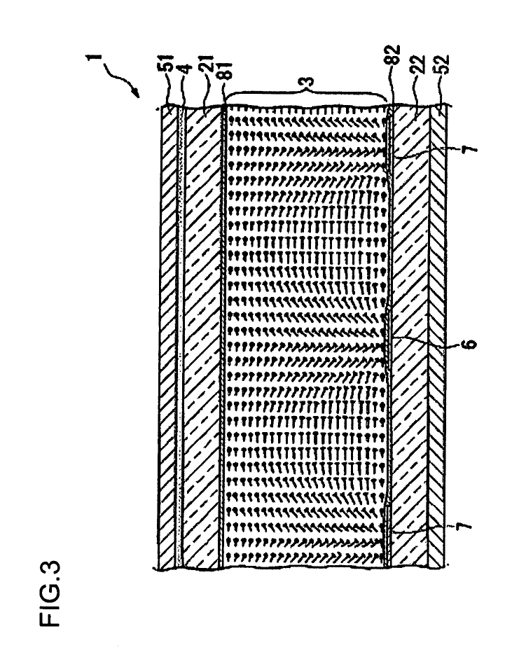

In the liquid crystal display device 1 of the present embodiment configured in such a manner, if an electric field is applied to the liquid crystal layer 3 by means of the pixel electrode 6 and the common electrode 7, as shown in FIG. 3, the liquid crystal molecules 31 are aligned according to the electric field. In this case, light incident on the liquid crystal layer 3 via the second polarizing plate 52 is double-refracted by means of the liquid crystal molecules 31, and thus the polarization direction of light rotates by 90°. For this reason, light transmitted through the liquid crystal layer 3 is emitted from the liquid crystal display device 1 via the retardation film 4 and the first polarizing plate 51, such that the white display in the liquid crystal display device 1 can be performed.

Moreover, if the electric field is not applied to the liquid crystal layer 3, as shown in FIG. 1, the liquid crystal molecules 31 are aligned according to the rubbing direction of the alignment films 81 and 82. In this case, light incident on the liquid crystal layer 3 via the second polarizing plate 52 reaches the first polarizing plate 51 without being circularly polarized. For this reason, light transmitted through the liquid crystal layer 3 is shielded by means of the first polarizing plate 51, such that the black display in the liquid crystal display device 1 can be performed.

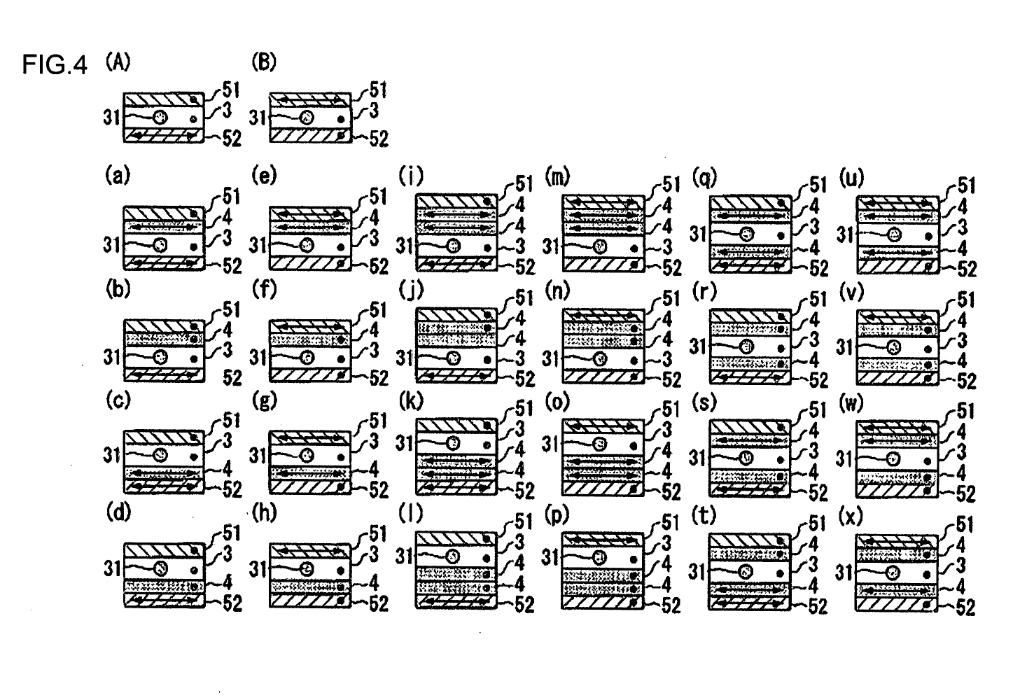

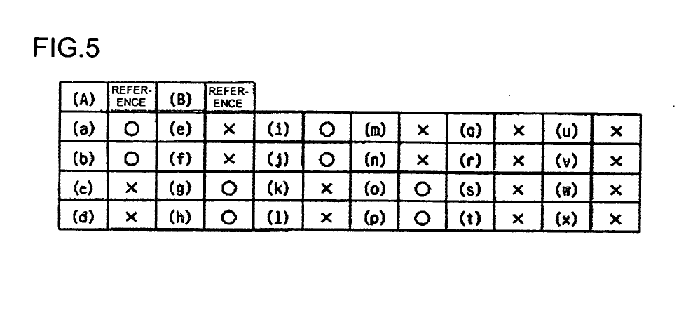

Next, an examination result of relationships among the alignment direction of the liquid crystal molecules 31, the transmission axes of the polarizing plates 51 and 52, and the slow axis of the retardation film 4 in the IPS mode liquid crystal display device will be described with reference to FIGS. 4 and 5.

FIG. 4 is a diagram showing a relationship among the alignment direction of the liquid crystal molecules, the transmission axis of the polarizing plate, and the slow axis of the retardation film. In FIG. 4, (A) and (B) show a liquid crystal display device not having the retardation film 4. Specifically, (A) shows a liquid crystal display device in which the alignment direction of the liquid crystal molecules 31 is made parallel to the transmission axis of the polarizing plate 51, and (B) shows a liquid crystal display device in which the alignment direction of the liquid crystal molecules 31 is made parallel to the transmission axis of the polarizing plate 52.

Further, (a) to (d) show a liquid crystal display device having a configuration that the retardation film 4 is arranged with respect to the liquid crystal display device shown in (A). Specifically, (a) shows a liquid crystal display device having a configuration that the retardation film 4 whose slow axis is made orthogonal to the alignment direction of the liquid crystal molecules 31 is arranged at the polarizing plate 51 side, and (b) shows a liquid crystal display device having a configuration that the retardation film 4 whose slow axis is made parallel to the alignment direction of the liquid crystal molecules 31 is arranged at the polarizing plate 51 side. Further, (c) shows a liquid crystal display device having a configuration that the retardation film 4 whose slow axis is made orthogonal to the alignment direction of the liquid crystal molecules 31 is arranged at the polarizing plate 52 side, and (d) shows a liquid crystal display device having a configuration that the retardation film 4 whose slow axis is made parallel to the alignment direction of the liquid crystal molecules 31 is arranged at the polarizing plate 52 side.

Further, (e) to (h) show a liquid crystal display device having a configuration that the retardation film 4 is arranged with respect to the liquid crystal display device shown in (B). Specifically, (e) shows a liquid crystal display device having a configuration that the retardation film 4 whose slow axis is made orthogonal to the alignment direction of the liquid crystal molecules 31 is arranged at the polarizing plate 51 side, and (f) shows a liquid crystal display device having a configuration that the retardation film 4 whose slow axis is made parallel to the alignment direction of the liquid crystal molecules 31 is arranged at the polarizing plate 51 side. Further, (g) shows a liquid crystal display device having a configuration that the retardation film 4 whose slow axis is made orthogonal to the alignment direction of the liquid crystal molecules 31 is arranged at the polarizing plate 52 side, and (h) shows a liquid crystal display device having a configuration that the retardation film 4 whose slow axis is made parallel to the alignment direction of the liquid crystal molecules 31 is arranged at the polarizing plate 52 side.

Further, (i) to (1) show a liquid crystal display device having a configuration that two retardation films 4 are arranged with respect to the liquid crystal display device shown in (A). Specifically, (i) shows a liquid crystal display device having a configuration that two retardation films 4 whose slow axes are made orthogonal to the alignment direction of the liquid crystal molecules 31 are arranged at the polarizing plate 51 side, and (j) shows a liquid crystal display device having a configuration that two retardation films 4 whose slow axes are made parallel to the alignment direction of the liquid crystal molecules 31 are arranged at the polarizing plate 51 side. Further, (k) shows a liquid crystal display device having a configuration that two retardation films 4 whose slow axes are made orthogonal to the alignment direction of the liquid crystal molecules 31 are arranged at the polarizing plate 52 side, and (l) shows a liquid crystal display device having a configuration that two retardation films 4 whose slow axes are made parallel to the alignment direction of the liquid crystal molecules 31 are arranged at the polarizing plate 52 side.

Further, (m) to (p) show a liquid crystal display device having a configuration that two retardation films 4 are arranged with respect to the liquid crystal display device shown in (B). Specifically, (m) shows a liquid crystal display device having a configuration that two retardation films 4 whose slow axes are made orthogonal to the alignment direction of the liquid crystal molecules 31 are arranged at the polarizing plate 51 side, and (n) shows a liquid crystal display device having a configuration that two retardation films 4 whose slow axes are made parallel to the alignment direction of the liquid crystal molecules 31 are arranged at the polarizing plate 51 side. Further, (o) shows a liquid crystal display device having a configuration that two retardation films 4 whose slow axes are made orthogonal to the alignment direction of the liquid crystal molecules 31 are arranged at the polarizing plate 52 side, and (p) shows a liquid crystal display device having a configuration that two retardation films 4 whose slow axes are made parallel to the alignment direction of the liquid crystal molecules 31 are arranged at the polarizing plate 52 side.

Further, (q) to (t) show a liquid crystal display device having a configuration that the retardation films 4 are arranged at the polarizing plate 51 side and the polarizing plate 52 side respectively with respect to the liquid crystal display device shown in (A). Specifically, (q) shows a liquid crystal display device having a configuration that the retardation films 4 whose slow axes are made orthogonal to the alignment direction of the liquid crystal molecules 31 are arranged at the polarizing plate 51 side and the polarizing plate 52 side respectively, and (r) shows a liquid crystal display device having a configuration that the retardation films 4 whose slow axes are made parallel to the alignment direction of the liquid crystal molecules 31 are arranged at the polarizing plate 51 side the polarizing plate 52 side respectively. Further, (s) shows a liquid crystal display device having a configuration that the retardation film 4 whose slow axis is made orthogonal to the alignment direction of the liquid crystal molecules 31 is arranged at the polarizing plate 51 side and the retardation film 4 whose slow axis is made parallel to the alignment direction of the liquid crystal molecules 31 is arranged at the polarizing plate 52. Further, (t) shows a liquid crystal display device having a configuration that the retardation film 4 whose slow axis is made parallel to the alignment direction of the liquid crystal molecules 31 is arranged at the polarizing plate 51 side and the retardation film 4 whose slow axis is made orthogonal to the alignment direction of the liquid crystal molecules 31 is arranged at the polarizing plate 52 side.

Further, (u) to (x) show a liquid crystal display device having a configuration that the retardation films 4 are arranged at the polarizing plate 51 side and the polarizing plate 52 side respectively with respect to the liquid crystal display device shown in (B). Specifically, (u) shows a liquid crystal display device having a configuration that the retardation films 4 whose slow axes are made orthogonal to the alignment direction of the liquid crystal molecules 31 are arranged at the polarizing plate 51 side and the polarizing plate 52 side respectively, and (v) shows a liquid crystal display device having a configuration that the retardation films 4 whose slow axes are made parallel to the alignment direction of the liquid crystal molecules 31 are arranged at the polarizing plate 51 side the polarizing plate 52 side respectively. Further, (w) shows a liquid crystal display device having a configuration that the retardation film 4 whose slow axis is made orthogonal to the alignment direction of the liquid crystal molecules 31 is arranged at the polarizing plate 51 side and the retardation film 4 whose slow axis is made parallel to the alignment direction of the liquid crystal molecules 31 is arranged at the polarizing plate 52. Further, (x) shows a liquid crystal display device having a configuration that the retardation film 4 whose slow axis is made parallel to the alignment direction of the liquid crystal molecules 31 is arranged at the polarizing plate 51 side and the retardation film 4 whose slow axis is made orthogonal to the alignment direction of the liquid crystal molecules 31 is arranged at the polarizing plate 52 side.

Moreover, the transmission axes of the polarizing plate 51 and the polarizing plate 52 are continuously orthogonal to each other, the value of Nz of the retardation film 4 is 0.3, and the in-plane phase difference (R) is 140 nm. Further, in FIG. 4, the substrates 21 and 22, the pixel electrodes 6, the common electrodes 7, and the alignment films 81 and 82 are not shown.

FIG. 5 is a table showing an examination result in the liquid crystal display device of each of (a) to (x) shown in FIG. 4. Moreover, in the table shown in FIG. 5, (A) and (B) are referred to as a liquid crystal display device having a reference configuration. Here, as for (a) to (x), in a case of no electric field, that is, in the black display, when the amount of transmitted light is lower than that of the liquid crystal display device having the reference configuration, ‘o’ is marked, as viewed from an azimuth direction of 25° and a polar angle direction of 60° (the wide angle side). Further, when the amount of transmitted light is higher than that of the liquid crystal display device having the reference configuration, ‘x’ is marked. Moreover, the azimuth direction described herein means an angle which increases in a counterclockwise direction with the right direction of the paper as 0°. For example, in FIG. 2B, the upper direction of the paper is 90°, the left direction of the paper is 180°, and the lower direction of the paper is 270°. Further, the polar angle direction described herein means an angle from the normal direction of the liquid crystal display device. In this case, the front surface of the liquid crystal display device is 0°.

Then, as shown in FIG. 5, it is confirmed that the liquid crystal display device of (a) having the configuration that the retardation film 4 whose slow axis is made orthogonal to the alignment direction of the liquid crystal molecules 31 is arranged at the polarizing plate 51 side, the liquid crystal display device of (b) having the configuration that the retardation film 4 whose slow axis is made parallel to the alignment direction of the liquid crystal molecules 31 is arranged at the polarizing plate 51 side, the liquid crystal display device of (g) having the configuration that the retardation film 4 whose slow axis is made orthogonal to the alignment direction of the liquid crystal molecules 31 is arranged at the polarizing plate 52 side, the liquid crystal display device of (h) having the configuration that the retardation film 4 whose slow axis is made parallel to the alignment direction of the liquid crystal molecules 31 is arranged at the polarizing plate 52 side, the liquid crystal display device of (i) having the configuration that two retardation films 4 whose slow axes are made orthogonal to the alignment direction of the liquid crystal molecules 31 are arranged at the polarizing plate 51 side, the liquid crystal display device of (j) having the configuration that two retardation film 4 whose slow axes are made parallel to the alignment direction of the liquid crystal molecules 31 are arranged at the polarizing plate 51 side, the liquid crystal display device of (o) having the configuration that two retardation films 4 whose slow axes are made orthogonal to the alignment direction of the liquid crystal molecules 31 are arranged at the polarizing plate 52 side, and the liquid crystal display device of (p) having the configuration that two retardation films 4 whose slow axes are made parallel to the alignment direction of the liquid crystal molecules 31 are arranged at the polarizing plate 52 side have the amount of transmitted light lower than that of the liquid crystal display device serving as a reference.

From this result, it is seen that, when the transmission axis direction of the polarizing plate 51 (or 52) arranged on the substrate with the retardation film 4 interposed therebetween is made parallel to the alignment direction of the liquid crystal molecules 31, the amount of transmitted light is lower than that of the liquid crystal display device serving as the reference. Then, since the amount of transmitted light in the black display becomes low, when the black display is viewed from the wide angle side, light leakage can be suppressed. Thus, when the liquid crystal display device is viewed from the wide angle side, the display characteristic can be enhanced.

Here, in the liquid crystal display device 1 of the present embodiment shown in FIG. 1, the transmission axis L1 of the first polarizing plate 51 arranged on the substrate 21 with the retardation film 4 interposed therebetween is made parallel to the alignment direction of the liquid crystal molecules 31. Therefore, according to the liquid crystal display device 1 of the present embodiment, when the black display is viewed from the wide angle side, the display characteristic can be enhanced.

Further, from the result shown in FIG. 5, even if the transmission axis L2 of the second polarizing plate 52 is made parallel to the alignment direction of the liquid crystal molecules 31 and the retardation film 4 is arranged at the second polarizing plate 52, that is, the substrate 22 is used as the one substrate of the present invention, the display characteristic can be enhanced when the black display is viewed from the wide angle side.

Further, from the result shown in FIG. 5, for the liquid crystal display device of each of (u) to (x) having the configuration that the retardation films 4 are arranged at the polarizing plate 51 and the polarizing plate 52 respectively, it is confirmed that the amount of transmitted light is not lower than that of the liquid crystal display device serving as the reference. For this reason, when two (plural) retardation films 4 are provided, all the retardation films 4 are preferably arranged near the polarizing plate (the side opposite to the liquid crystal of the one substrate) which has the transmission axis parallel to the alignment direction of the liquid crystal molecules 31.

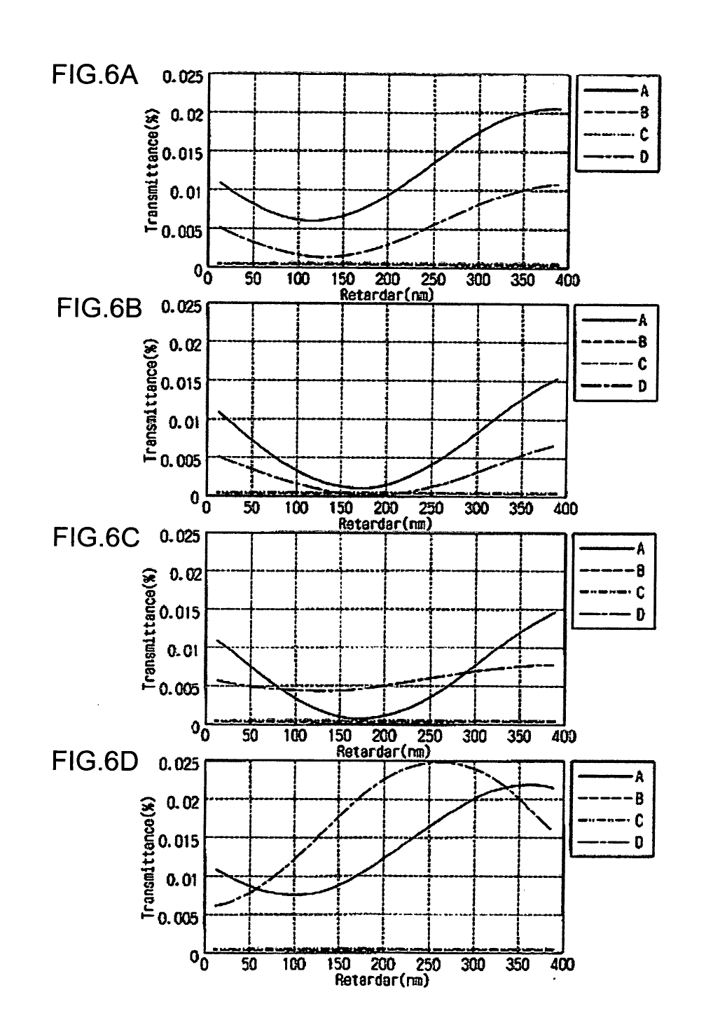

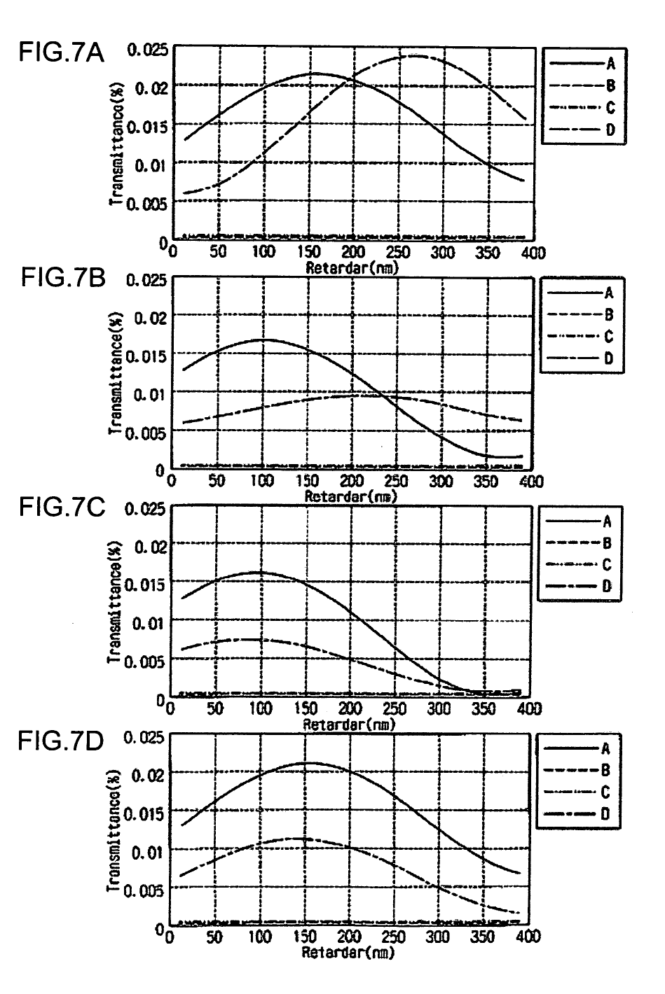

Next, when the value of Nz of the retardation film 4 and the slow axis direction of the retardation film 4 changes, an examination result of a relationship between brightness of the black display and the in-plane phase difference (R) of the retardation film 4 will be described with reference to FIGS. 6A to 7D.

Moreover, when the refractive index of the retardation film 4 in an X direction parallel to the surface of the retardation film 4 is nx, the refractive index of the retardation film 4 in a Y direction parallel to the surface of the retardation film 4 and orthogonal to the X direction is ny, and the refractive index of the retardation film 4 in a thicknesswise direction of the retardation film 4 (a Z direction) is nz, the above-described value of Nz is defined by the following equation (1). Further, when the thickness of the retardation film 4 is d, the in-plane phase difference (R) is defined by the following equation (2).
Nz=(nx−nz)/(nx−ny) (1)
R=(nx−ny)×d (2)

Further, in this examination, the liquid crystal display device 1 is viewed from four azimuth directions of 25°, 70°, 160°, and 205° in a state in which the polar angle direction is 60° (wide angle side). In FIGS. 6A to 7D, a graph A represents the case of the azimuth of 25°, a graph B represents the case of the azimuth of 70°, a graph C represents the case of the azimuth of 160°, and a graph D represents the case of the azimuth of 205°. Further, the phase difference value of the liquid crystal layer 3 is set to 0.33 μm and the transmission axis of the first polarizing plate 51 is made parallel to the alignment direction of the liquid crystal molecules 31.

FIGS. 6A to 6D are diagrams showing results in a state in which the slow axis direction of the retardation film 4 is made parallel to the alignment direction of the liquid crystal molecules. Specifically, FIG. 6A shows the case in which the value of Nz of the retardation film 4 is 0 (zero), FIG. 6B shows the case in which the value of Nz of the retardation film is 0.3, FIG. 6C shows the case in which the value of Nz of the retardation film is 0.6, and FIG. 6D shows the case in which the value of Nz of the retardation film is 1.0.

Referring to the graph B and the graph C shown in FIGS. 6B and 6C from FIGS. 6A to 6D, it can be seen that, when the in-plane phase difference of the retardation film 4 is in a range of from 100 to 250 nm, brightness of the black display becomes low. Therefore, in a state in which the slow axis direction of the retardation film 4 is made to parallel to the alignment direction of the liquid crystal molecules, in order to enhance the display characteristic of the black display, it can be seen that the value of Nz of the retardation film 4 is preferably in a range of from 0.3 to 0.6 and the in-plane phase difference of the retardation film 4 is preferably in a range of from 100 to 250 nm.

Further, FIGS. 7A to 7D are diagrams showing results in a state in which the slow axis direction of the retardation film 4 is made orthogonal to the alignment direction of the liquid crystal molecules. Specifically, FIG. 7A shows the case in which the value of Nz of the retardation film 4 is 0 (zero), FIG. 7B shows the case in which the value of Nz of the retardation film is 0.3, FIG. 7C shows the case in which the value of Nz of the retardation film is 0.6, and FIG. 7D shows the case in which the value of Nz of the retardation film is 1.0.

With comparing the graphs A to D shown in FIGS. 7A to 7D to the graphs A to D shown in FIGS. 6A to 6D, the graphs A to D shown in FIGS. 6A to 6D exhibit more favorable results than the graphs A to D shown in FIGS. 7A to 7D.

Therefore, in order to enhance the display characteristic of the black display in the liquid crystal display device 1 of the present embodiment, it can be seen that the slow axis direction of the retardation film 4 is preferably made parallel to the alignment direction of the liquid crystal molecules.

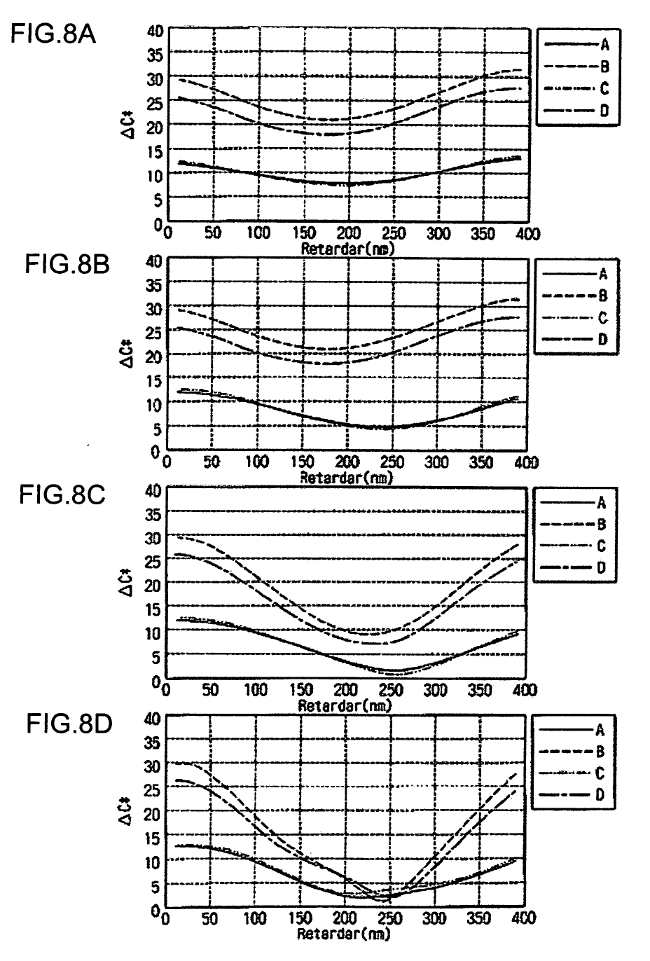

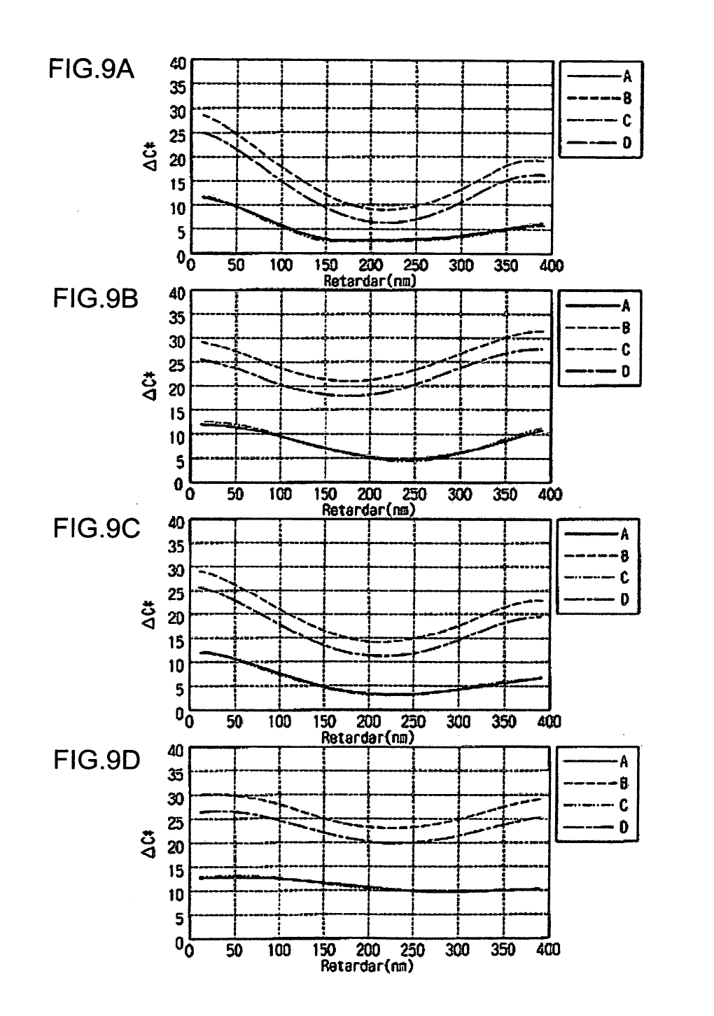

Next, when the value of Nz of the retardation film 4 and the slow axis direction of the retardation film 4 changes, an examination result of a relationship between the coloring problem of the white display (chromaticity difference (ΔC*)) and the in-plane phase difference (R) of the retardation film 4 will be described with reference to FIGS. 8A to 9D. Moreover, in this examination, the liquid crystal display device 1 is viewed from four azimuth directions of 25°, 115°, 205°, and 295° when the polar angle direction is 60°. In FIGS. 8A to 9D, a graph A represents the case of the azimuth of 25°, a graph B represents the case of the azimuth of 115°, a graph C represents the case of the azimuth of 205°, and a graph D represents the case of the azimuth of 295°. Further, the phase difference value of the liquid crystal layer 3 is set to 0.33 μm and the transmission axis of the first polarizing plate 51 is made parallel to the alignment direction of the liquid crystal molecules 31.

FIGS. 8A to 8D are diagrams showing results in a state in which the slow axis direction of the retardation film 4 is made parallel to the alignment direction of the liquid crystal molecules. Specifically, FIG. 8A shows the case in which the value of Nz of the retardation film 4 is 0 (zero), FIG. 8B shows the case in which the value of Nz of the retardation film is 0.3, FIG. 8C shows the case in which the value of Nz of the retardation film is 0.6, and FIG. 8D shows the case in which the value of Nz of the retardation film is 1.0. Further, FIGS. 9A to 9D are diagrams showing results in a state in which the slow axis direction of the retardation film 4 is made orthogonal to the alignment direction of the liquid crystal molecules. Specifically, FIG. 9A shows the case in which the value of Nz of the retardation film 4 is 0 (zero), FIG. 9B shows the case in which the value of Nz of the retardation film is 0.3, FIG. 9C shows the case in which the value of Nz of the retardation film is 0.6, and FIG. 9D shows the case in which the value of Nz of the retardation film is 1.0.

As apparent from FIGS. 8A to 9D, irregardless of the value of Nz and the slow axis direction of the retardation film 4, when the in-plane phase difference of the retardation film 4 is in a range of from 150 to 250 nm, it is confirmed that the chromaticity difference, that is, the coloring problem of the white display is small.

Therefore, as shown in FIGS. 6A to 9D, in the liquid crystal display device 1 of the present embodiment, in order to realize more favorable display characteristic, it is seen that, preferably, the slow axis of the retardation film 4 is made parallel to the alignment direction of the liquid crystal molecules 31, the value of Nz of the retardation film is in a range of from 0.3 to 0.6, and the in-plane phase difference of the retardation film is in a range of 100 to 250 nm (more preferably, in a range of from 150 to 250 nm).

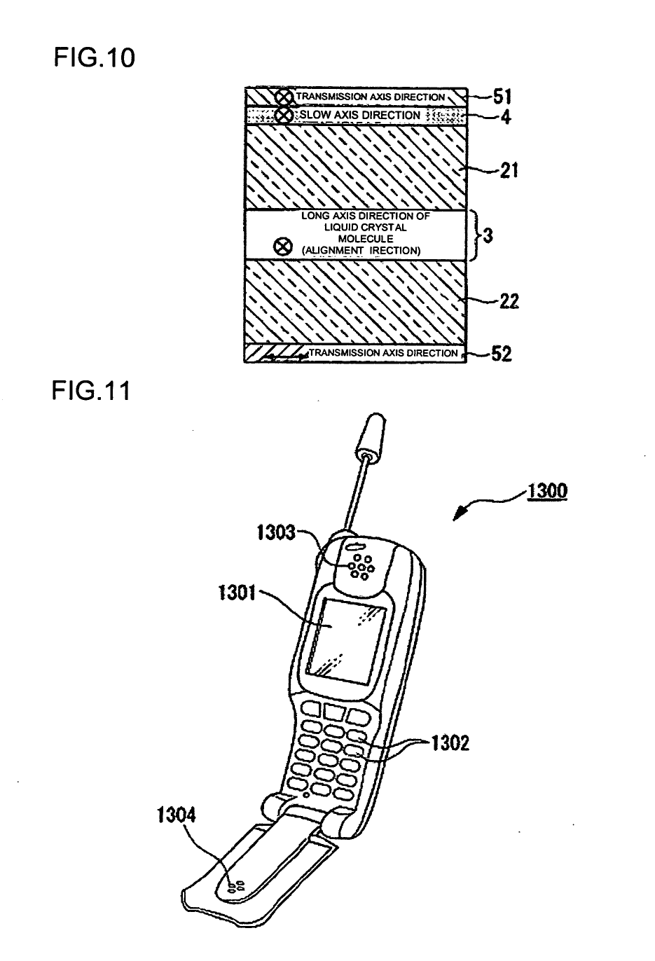

Next, a best configuration of a liquid crystal display device of the present invention will be described with reference to FIG. 10.

FIG. 10 is a schematic cross-sectional view showing a best configuration of a liquid crystal display device of the present invention. Moreover, in FIG. 10, the pixel electrodes 6, the common electrodes 7, and the alignment films 81 and 82 shown in FIG. 1 are not shown.

As shown in FIG. 10, according to the best configuration of the liquid crystal display device of the present invention, the slow axis of the retardation film 4 is made parallel to the alignment direction of the liquid crystal molecules and the transmission axis direction of the first polarizing plate 51 arranged on the substrate with the retardation film 4 interposed therebetween is made parallel to the alignment direction of the liquid crystal molecules and the slow axis direction of the retardation film 4. Further, the value of Nz of the retardation film 4 is set to 0.3 and the in-plane phase difference is set to 170 nm.

According to the liquid crystal display device of the present invention having such a configuration, the pixel electrode and the common electrode are not needed to be formed in the V shape, and thus the aperture ratio of the pixel can be sufficiently ensured. Further, the slow axis of the retardation film 4 is made parallel to the alignment direction of the liquid crystal molecules 31, the value of Nz of the retardation film is set to 0.3, and the in-plane phase difference is set to 170 nm. Thus, as viewed from the wide angle side, the brightness of the black display and the coloring problem of the white display can be reduced. As a result, more favorable display characteristic can be realized.

Next, an electronic apparatus of the present invention will be described with reference to FIG. 11.

FIG. 11 is a perspective view showing an example of an electronic apparatus of the present invention. A cellular phone 1300 shown in FIG. 11 has the liquid crystal display device of the present invention as a small display unit 1301, a plurality of operating buttons 1302, a receiver 1303, and a transmitter 1304.

The display device of each of the above-described embodiments can be suitably used for an electronic book, a personal computer, a digital still camera, a liquid crystal television, a viewfinder-type or monitor-direct-view-type video tape recorder, a car navigation device, a pager, an electronic organizer, an electronic calculator, a word processor, a workstation, a videophone, a POS terminal, an apparatus having a touch panel, or the like, in addition to the cellular phone, as image display means. In all the electronic apparatuses, display with brightness and wide viewing angle can be performed.

As such, the preferred embodiments of a liquid crystal display device and an electronic apparatus according to the present invention are described with the accompanying drawings, but it is needless to say that the present invention is not limited to the embodiments. The shapes or combination of the respective elements shown in the above-described embodiments are just examples, and various modifications can be made based on design demands within a scope without departing from the subject matter of the present invention.

For example, in the liquid crystal display device of the above-described embodiment, a color filter may be arranged between the alignment film 81 and the substrate 21. For example, color filters for respective colors RGB are sequentially arranged for pixels respectively, such that a liquid crystal display device capable of full color display can be implemented. Then, when the liquid crystal display device of the present invention is applied to such a liquid crystal display device capable of full color display, a liquid crystal display device in which the coloring problems when displaying the respective colors are suppressed and the brightness at the time of the black display is reduced can be implemented.

1. A liquid crystal display device having a liquid crystal interposed between a pair of substrates in which an electric field parallel to a surface of each of the substrates is applied to the liquid crystal, thereby changing a display state, the liquid crystal display device comprising:
a retardation film arranged at a side opposite to the liquid crystal of one of the substrates;
a first polarizing plate which is arranged at a side opposite to the substrate of the retardation film and which has a transmission axis parallel to an alignment direction of the liquid crystal; and
a second polarizing plate which is arranged at a side opposite to the liquid crystal of the other substrate and which has a transmission axis orthogonal to the alignment direction of the liquid crystal.

2. The liquid crystal display device according to claim 1,
wherein a slow axis of the retardation film and the alignment direction of the liquid crystal are parallel to each other.

3. The liquid crystal display device according to claim 1,
wherein a plurality of retardation films are provided.

4. The liquid crystal display device according to claim 1,
wherein the value of Nz of the retardation film is in a range of from 0.3 to 0.6 and an in-plane phase difference of the retardation film is in a range of from 100 to 250 nm.

5. An electronic apparatus comprising a liquid crystal display device as claimed in claim 1.
